(19) United States
(12) Patent Application Publication
(10) Pub. No.: US 2008/0175599 A1
(43) Pub. Date: Jul. 24, 2008

(54) OPTICAL PULSE GENERATOR, SEMICONDUCTOR LASER MODULE, AND SEMICONDUCTOR LASER DRIVE APPARATUS

(75) Inventor: Shin Masuda, Tokyo (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ADVANTEST CORPORATION, TOKYO (JP)

(21) Appl. No.: 12/014,082

(22) Filed: Jan. 14, 2008

(30) Foreign Application Priority Data
Jan. 16, 2007 (JP) JP2007-006961

(51) Int. Cl. H01S 3/10; H04B 10/04

(52) U.S. Cl. 398/189; 372/26

(57) ABSTRACT

Provided are: an RF signal generator 110 which generates and outputs an RF signal having a signal waveform in which the potential of the signal changes to be alternately positive and negative with respect to a reference potential; a semiconductor laser 140 which receives, at its one end, a drive current which is based on the signal output from the RF signal generator 110; and a rectifier 150 which receives the drive current at its one end which has a polar directivity opposite to that of the one end of the semiconductor laser 140, with the other end of the semiconductor laser 140 and the other end of the rectifier 150 connected to a common potential.

### CROSS REFERENCE TO RELATED APPLICATION

The present application claims priority from a Japanese Patent Application No. 2007-6961 filed on Jan. 16, 2007 the contents of which are incorporated herein by reference.

### BACKGROUND

1. Technical Field

The present invention relates to an optical pulse generator, a semiconductor laser module, and a semiconductor laser drive apparatus. Particularly, the present invention relates to an optical pulse generator, a semiconductor laser module, and a semiconductor laser drive apparatus, which are used in generating optical pulses having a small pulse width using a semiconductor laser as a light source.

2. Description of the Related Art

Pulse laser (hereinafter referred to as “optical pulse”) having a very small pulse width, which is used to improve the density of signals transmitted through optical communications, is also expected to be applied to the fields of measurement, control, manufacture, etc. with its spatial locality, high peaking characteristic, and large range of wavelength utilized. Gain switching is one way to generate optical pulses.

The method of driving a semiconductor laser by gain switching can generate a sequence of optical pulses having a pulse width of about several ten picoseconds. However, in a case where a comb generator is used for generating electric pulses, the range in which the cyclic frequency of pulses can be changed is limited because the band of the comb generator is narrow. Specifically, the range of frequencies of pulse oscillation of a 100 MHz comb generator is only about 90 MHz to 110 MHz.

Meanwhile, in the case of gain switching using a sinusoidal electric signal, the cyclic frequency can be arbitrarily set. However, because it is not desirable if a current that is directed oppositely to the polar directivity of the semiconductor laser flows into the semiconductor laser, a drive current obtained from a sinusoidal wave signal which is adjusted with a bias current superimposed thereon so as not to allow its polar directivity to be reversed is fed to the semiconductor laser. Therefore, a direct current smaller than a threshold current flows through the semiconductor laser even when the semiconductor laser is extinguished. Due to this direct current, light is spontaneously emitted inside the semiconductor laser randomly, thereby increasing the timing jitter attributed to the fluctuation of photon density. The timing jitter is especially increased when the cyclic frequency is low, to an unignorable level of about 10 picoseconds, when the cyclic frequency is as low as about 100 MHz.

Patent Literature 1 identified below discloses a method for reducing such timing jitter as described above. The optical pulse generator described in this literature drives a voltage-controlled oscillator as signal source by gain switching, while putting the oscillator under feedback control by branching the generated optical pulses in order to compare the phase of the pulses with respect to a reference RF signal source so that the oscillation frequency of the voltage-controlled oscillator is phased-locked with the reference RF signal (PLL). The literature insists that this method can reduce the timing jitter to about 1 picosecond.

As another method, there is a method of successively injecting, into a semiconductor laser which is the object of gain switching drive, light generated by another light source. Patent Literature 2 identified below describes that it is possible to reduce timing jitter by externally injecting electrically-induced light rays having generally the same wavelength into the active layer of the semiconductor laser, which is the object of gain switching drive, thereby suppressing the fluctuation of the photon density inside the semiconductor laser.

[Patent Literature 1] Unexamined Japanese Patent Application Publication No. 2000-077768

[Patent Literature 2] Unexamined Japanese Patent. Application. Publication No. H11-284266

[Non-Patent Literature 1] O. Ohta, et. al., “Generation of 650 Femtosecond optical pulses from a Gain-Switched Laser Diode” Jpn. Appl. Phys., Vol. 38, pp. 5905-5909 (1999)

The method of stabilizing optical pulses by phase locking (PLL) can achieve a high accuracy but has to use a complex and large-sized circuit. Phase noise might be the cause of timing jitter. The range of levels of phase noises that can be reduced by this method depends on the bandwidth of the loop filter packaged on the PLL circuit. Hence, it is difficult to suppress a high-speed timing jitter.

The method of injecting electrically induced light into the active layer of the semiconductor laser is effective for a high-frequency timing jitter. However, as described in Non-Patent Literature 1, it is difficult to reduce the fluctuation of a low-frequency timing jitter by this method.

Further, in order that a semiconductor laser which is driven by gain switching operates with a small jitter, a large current with a steep rising characteristic has to be injected into the semiconductor laser. However, in the case of gain switching drive using a sinusoidal wave, the amplitude of the signal that can be applied is limited because it is necessary to prevent any current that is directed oppositely to the polar directivity of the light emitting element from flowing into the light emitting element.

For example, an optical pulse generator as a light source for optical sampling is required to be capable of successively changing the cyclic frequency and dealing with signals under measurement having various frequencies. Such an optical pulse generator is also required to allow only small timing jitter. However, an optical pulse generator which can generate a desired optical pulse with a simple circuit structure is unavailable yet, as described above.

### SUMMARY

Hence, according to one aspect of the present invention, an object is to provide an optical pulse generator, a semiconductor laser module, and a semiconductor laser drive apparatus, which can overcome the above-described problem. The above and other objects can be achieved by combinations described in the independent claims. The dependent claims define further advantageous and exemplary combinations of the innovations herein.

That is, according to a first aspect of the present invention, there is provided an optical pulse generator including: an RF signal generator which generates and outputs an RF signal having a signal waveform in which the potential of the signal changes to be positive and negative with respect to a reference potential; a semiconductor laser which receives, at its one end, a drive current based on the signal output from the RF signal generator; and a rectifying element which receives the drive current at its one end having a polar directivity opposite to that of the one end of the semiconductor laser, with the other end of the semiconductor laser and the other end of the rectifier connected to a common potential.

According to a second aspect of the present invention, there is provided a semiconductor laser module including: a semiconductor laser that is supplied with a drive current from an RF signal generator which generates and outputs an RF signal having a signal waveform in which the potential of the signal changes to be positive and negative with respect to a reference potential, the semiconductor laser receiving, at its one end, the drive current which is based on the RF signal; and a rectifying element which receives the drive current at its one end having a polar directivity opposite to that of the one end of the semiconductor laser, wherein the other end of the semiconductor laser and the other end of the rectifier are connected to a common potential.

Further, according to a third aspect of the present invention, there is provided a semiconductor laser drive apparatus that includes: an RF signal generator which generates and outputs an RF signal having a signal waveform in which the potential of the signal changes to be positive and negative with respect to a reference potential; and a rectifying element which receives, at its one end, a drive current which is based on the signal output from the RF signal generator, wherein the semiconductor laser drive apparatus drives a semiconductor laser which receives the drive current at its one end having a polar directivity opposite to that of the one end of the rectifying element, and whose other end is connected to a potential common to the other end of the rectifying element.

The summary clause does not necessarily describe all necessary features of the embodiments of the present invention. The present invention may also be a sub-combination of the features described above.

### BRIEF DESCRIPTION OF THE DRAWINGS

FIG. 1 is a circuit diagram exemplarily showing the configuration of an optical pulse generator 100 according to one example.

FIG. 2 shows signal waveforms at given locations of the optical pulse generator 100 shown in FIG. 1.

FIG. 3 is a circuit diagram exemplarily showing the configuration of an optical pulse generator 200 according to another example.

FIG. 4 shows signal waveforms at given locations of the optical pulse generator shown in FIG. 3.

FIG. 5 is a circuit diagram exemplarily showing an optical pulse generator 300 according to yet another example.

FIG. 6 shows signal waveforms at given locations of the optical pulse generator 300 shown in FIG. 5.

FIG. 7 is a circuit diagram exemplarily showing the configuration of an optical pulse generator 400 according to yet another embodiment.

FIG. 8 shows signal waveforms at given locations of the optical pulse generator 400 shown in FIG. 7.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

### Example 1

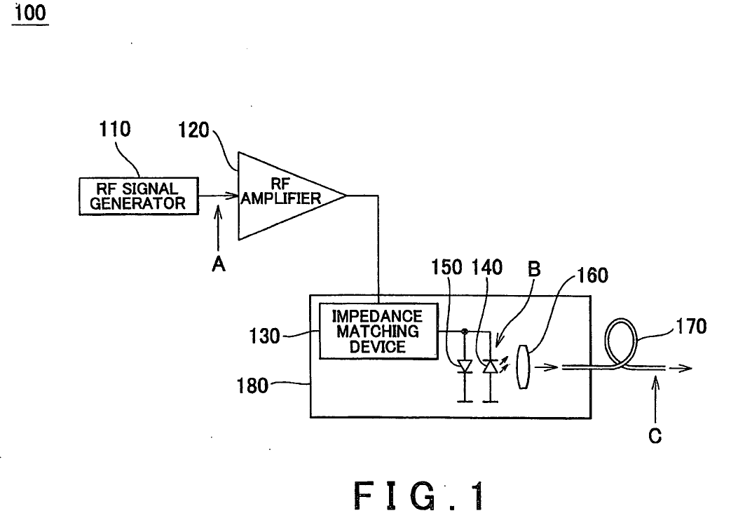

FIG. 1 is a circuit diagram exemplarily showing the configuration of an optical pulse generator 100 according to one example. As shown in FIG. 1, the optical pulse generator 100 includes a semiconductor laser module 180 including a semiconductor laser 140, and an RF signal generator 110, which is the signal source of a drive current to be supplied to the semiconductor laser module 180.

The RF signal generator 110 generates an RF signal having the same frequency as the cyclic frequency of optical pulses which are to be finally output to the outside. The output from the RF signal generator 110 is amplified by an RF amplifier 120 and then input to the semiconductor laser module 180 as a drive current. The RF amplifier 120 amplifies the signal output from the RF signal generator 110 to, for example, 30 dBm, and outputs a large power of about 1 W. When such a large power is applied to the semiconductor laser 140 in a direction opposite to the polar directivity of the semiconductor laser 140, the semiconductor laser 140 might be destroyed.

As the semiconductor laser 140, a Fabry-Perot semiconductor laser device, a DFB (Distributed FeedBack) laser, a VCSEL (Vertical Cavity Surface Emitting Laser), etc. can be used. A schottky barrier diode can be used as a rectifier 150.

The semiconductor laser module 180 includes an impedance matching device 130 which is the interface to the RF amplifier 120, a semiconductor laser 140 having its one end connected to the impedance matching device 130, and a rectifier 150.

Here, one end of the semiconductor laser 140 and one end of the rectifier 150, having the opposite polar directivities to each other, are connected to the impedance matching device 130. The other end of the semiconductor laser 140 and the other end of the rectifier 150 are connected to the ground potential. Accordingly, when a current whose polar directivity might reverse is supplied to the semiconductor laser module 180, the currents that will flow through the semiconductor laser 140 and the rectifier 150 will have specific polar directivities respectively.

The semiconductor laser module 180 further includes an optical coupler lens 160 that focuses the laser light emitted from the semiconductor laser 140, and an output port optical fiber 170 into which the laser light focused by the optical coupler lens 160 is injected from its one end. The other end of the output port optical fiber 170 extends out of the semiconductor laser module 180, and is brought to any place according to the use of the generated optical pulses.

Even if the semiconductor laser module 180 does not have the impedance matching device 130, the optical pulse generator 100 can at least function. However, by matching the impedance of the entire signal line through which the drive current flows to 50Ω, it is possible to prevent degradation of the peak value of the signal output from the RF signal generator 110.

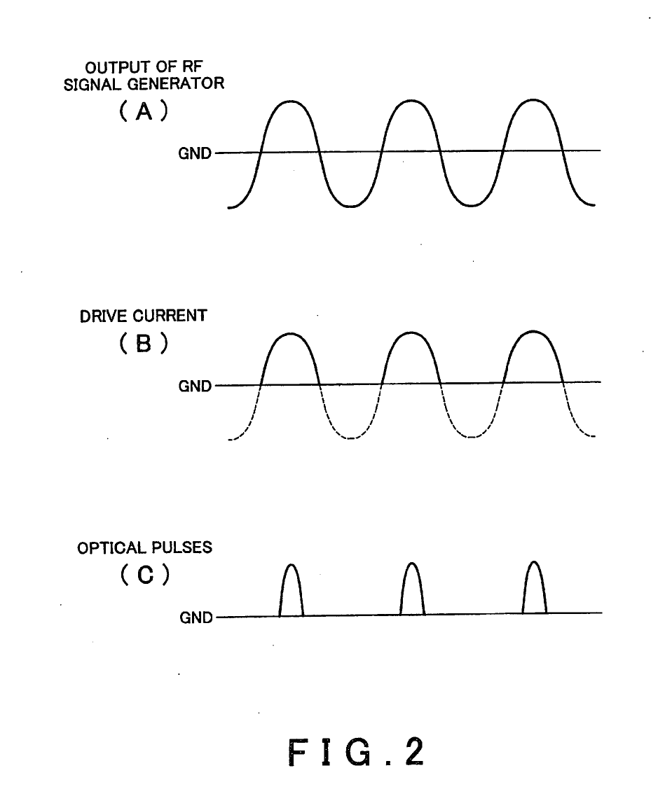

FIG. 2 shows the waveforms of the signal at given locations of the optical pulse generator 100 shown in FIG. 1. As shown in FIG. 2, the signal waveform (A) at the output of the RF signal generator 110 represents a sinusoidal wave, and has an amplitude which is symmetric with respect to the ground potential.

Like this, the output from the RF signal generator 110 can changes its potential symmetrically with respect to the GND potential. This makes it possible to generate an RF signal having high waveform accuracy by using a simple circuit.

In a case where a drive current having such a signal waveform is supplied to the semiconductor laser module 180, the part of the signal waveform (A) that is lower than the ground potential as shown by a broken line in the drawing flows into the rectifier 150. Accordingly, the signal waveform (B) of the drive current that is to be injected into the semiconductor laser 140 is only the part of the signal waveform (A) that is equal to or higher than the ground potential. The semiconductor laser 140 that is driven by gain switching using the drive current having the signal waveform (B) outputs optical pulses having the signal waveform (C) from the output port optical fiber 170. The cyclic frequency of the optical pulses is the same as the frequency of the signal waveform (A) of the drive current.

Here, during the period in which the signal waveform (B) of the drive current does not rise from the ground potential, the current flows into the rectifier 150 not into the semiconductor laser 140. Accordingly, a situation that the drive current equal to or smaller than the threshold value flows into the semiconductor laser 140 being extinguished to cause spontaneous light emission will not occur. Hence, any timing jitter that is caused by fluctuation of photon density is reduced, to, for example, about 10 picoseconds to 1 picosecond.

Further, since the current that is directed oppositely to the polar directivity of the semiconductor laser 140 flows into the rectifier 150, there is no limitation on the amplitude of the drive current, so a drive current having the largest amplitude possible within the range of voltage withstand of the semiconductor laser 140 can be injected. Further, since the cyclic frequency of the optical pulses to be output depends on the frequency of the signal output from the RF signal generator 110, there is no limitation on the cyclic frequency, either.

Hence, there will be provided a semiconductor laser module 180 including: the semiconductor laser 140 that is supplied with a drive current from the RF signal generator 110 which generates and outputs an RF signal having a signal waveform in which the potential of the signal changes to be alternately positive and negative with respect to a reference potential, and that receives the drive current which is based on the RF signal at its one end; and the rectifier 150 that receives the drive current at its one end having a polar directivity opposite to that of the one end of the semiconductor laser 140, with the other end of the semiconductor laser 140 and the other end of the rectifier 150 connected to a common potential. Hence, it is possible to constitute an optical pulse generator 100 which drives the laser by many drive apparatuses that output signals whose potential changes to be alternately positive and negative with respect to the ground potential, and which thereby generates optical pulses with less timing jitter.

Further, by also integrating the RF signal generator 110, it is possible to constitute an optical pulse generator 100 including: the RF signal generator 110 which generates and outputs an RF signal having a signal waveform in which the potential of the signal is alternately positive and negative with respect to a reference potential; a semiconductor laser 140 which receives, at its one end, a drive current which is based on the signal output from the RF signal generator 110; and a rectifier 150 which receives the drive current at its one end having a polar directivity opposite to that of the one end of the semiconductor laser 140, with the other end of the semiconductor laser 140 and the other end of the rectifier 150 connected to a common potential. Hence, it is possible to provide an optical pulse generator 100 which generates optical pulses having a cyclic frequency the same as the frequency of the RF signal. The optical pulses output from this optical pulse generator 100 include less timing jitter, which is due to the fluctuation of photon density. Accordingly, the optical pulses output from this optical pulse generator can be suitably used for optical communication, optical manufacture, optical sampling, etc.

### Example 2

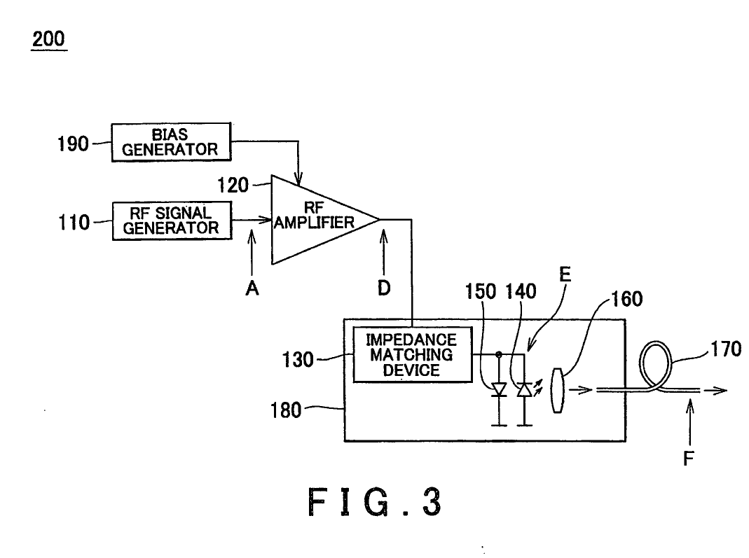

FIG. 3 is a circuit diagram exemplarily showing the configuration of an optical pulse generator 200 according to another example. As shown in FIG. 3, the optical pulse generator 200 is different from the optical pulse generator 100 shown in FIG. 1 in that the optical pulse generator 200 includes a bias generator 190 which supplies a bias current to the RF amplifier 120. With regard to the other components, those that are common to the optical pulse generator 100 shown in FIG. 1 will be denoted by the same reference numerals and will not be explained again.

Here, the bias generator 190 can change the midpoint of the amplitude of an RF signal, which is originally at the ground potential, with respect to the ground potential, and can minimize timing jitter by changing the timing at which the semiconductor laser 140 emits light.

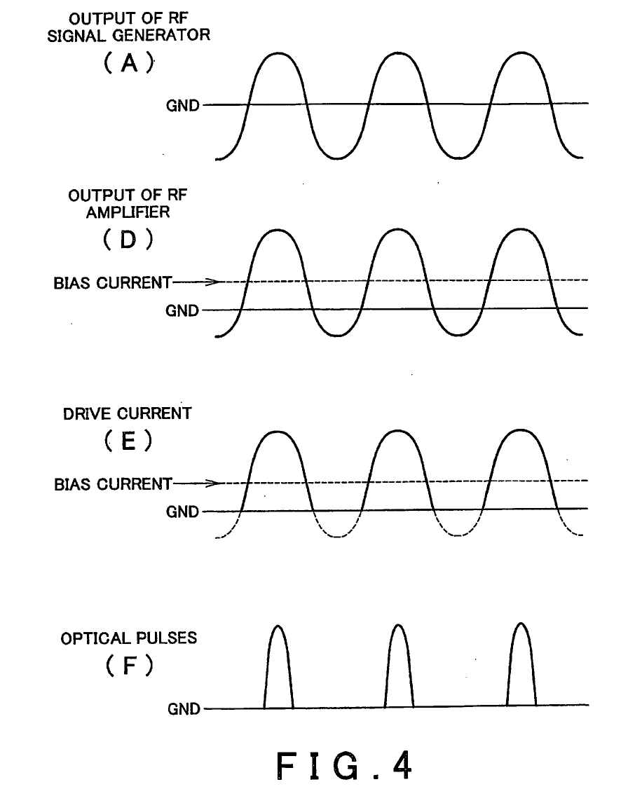

FIG. 4 shows the signal waveforms at given locations of the optical pulse generator 200 shown in FIG. 3. As shown in FIG. 4, the signal waveform (A) at the output of the RF signal generator 110 is a sinusoidal wave likewise the optical pulse generator 100 shown in FIG. 1, and has an amplitude that is symmetric with respect to the ground potential. However, since a bias current supplied from the bias generator 190 is superimposed on the signal at the RF amplifier 120, the signal waveform (D) of the signal supplied to the semiconductor laser module 180 is positive and negative symmetrically with respect to the threshold current value of the semiconductor laser 140.

Hence, in the semiconductor laser module 180, a drive current having a signal waveform (E) that is shifted to be higher with respect to the ground potential is injected into the semiconductor laser 140. In this manner, a bias current appropriate for the threshold current of the semiconductor laser 140 can be applied to the potential of the signal output from the RF signal generator 110.

### Example 3

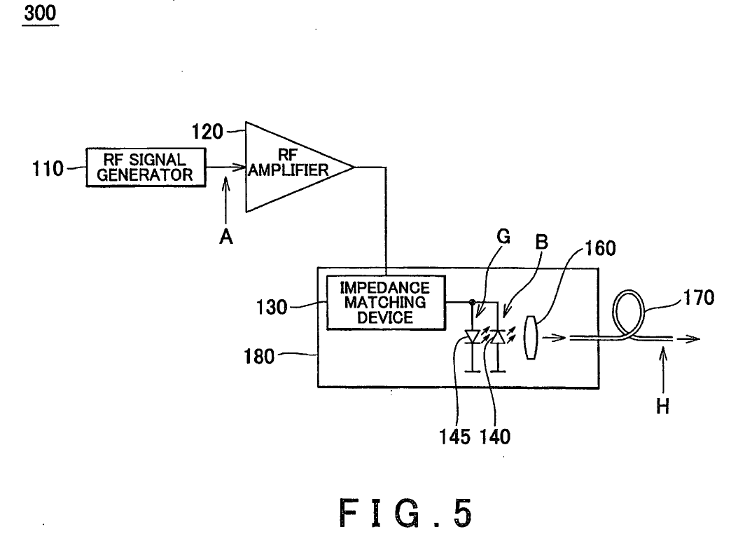

FIG. 5 is a circuit diagram exemplarily showing the configuration of an optical pulse generator 300 according to yet another example. As shown in FIG. 5, the optical pulse generator 300 is different from the optical pulse generator 100 shown in FIG. 1 in that a semiconductor laser 145 is used in the semiconductor laser module 180 of the optical pulse generator 300 instead of the rectifier 150 which is connected to the semiconductor laser 140 in parallel to have an opposite polar directivity. With regard to the other components, those that are common to the optical pulse generator 100 shown in FIG. 1 will be denoted by the same reference numerals and will no be explained again.

Here, also the semiconductor laser 145 which is provided as a rectifier 150 is optically connected to the output port optical fiber 170 via the optical coupler lens 160. Hence, during a period in which a current supplied to the semiconductor laser module 180 flows in the forward direction with respect to the polar directivity of the semiconductor laser 140, the semiconductor laser 145 generates optical pulses. These optical pulses emitted from the semiconductor laser 145 are also output through the output port optical fiber 170.

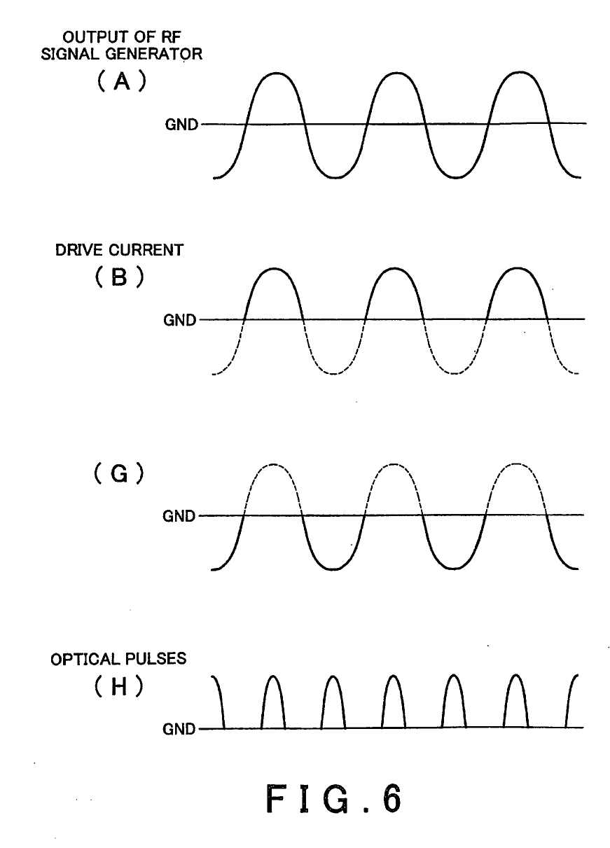

FIG. 6 shows signal waveforms at given locations of the optical pulse generator 300 shown in FIG. 1. As shown in FIG. 6, the signal waveform (A) of a drive current to be injected into the semiconductor laser 140 is the same as the waveform used in the optical pulse generator 100 shown in FIG. 1.

However, during the period of the signal waveform (A) that is shown by a broken line, the signal having the signal waveform (G) is injected into the semiconductor laser 145 connected oppositely. Accordingly, also the semiconductor laser 145 generates optical pulses having a cyclic frequency the same as the frequency of the signal waveform (A) of the signal output from the RF signal generator 110.

As explained above, the optical pulses output from the semiconductor laser 145 are also output through the output port optical fiber 170, the same as the optical pulses output from the semiconductor laser 140. Accordingly, the optical pulses output from the output port optical fiber 170 have the signal waveform (H) having a cyclic frequency twice as high as the frequency of the signal waveform (A) of the signal output from the RF signal generator 110.

### Example 4

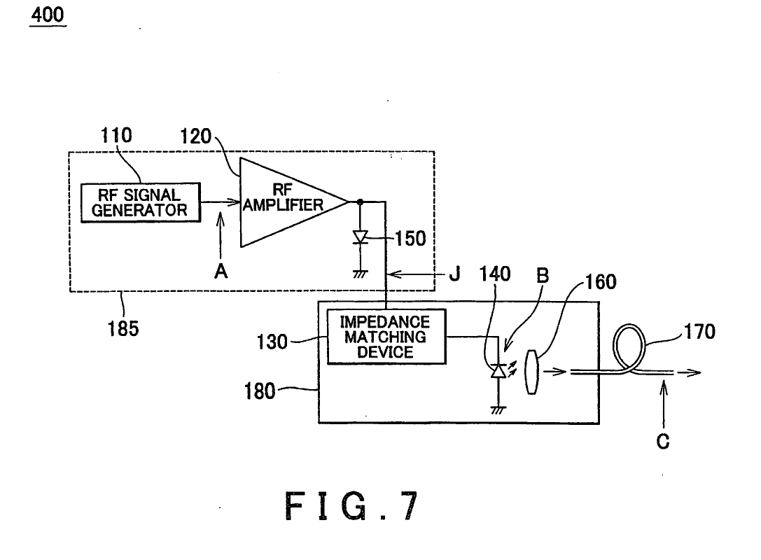

FIG. 7 is a circuit diagram exemplarily showing the configuration of an optical pulse generator 400 according to yet another example. As shown in FIG. 7, the optical pulse generator 400 is different from the optical pulse generator 100 shown in FIG. 1 in that the rectifier 150 is disposed outside the semiconductor laser module 180. In other words, only the semiconductor laser 140 is supplied with a drive current through the impedance matching device 130. With regard to the other components, those that are common to the optical pulse generator 100 shown in FIG. 1 will be denoted by the same reference numerals and will not be explained again.

As shown in FIG. 7, the optical pulse generator 400 includes a rectifier 150 which has its one end connected to the output of the RF amplifier 120 and its other end connected to the ground potential.

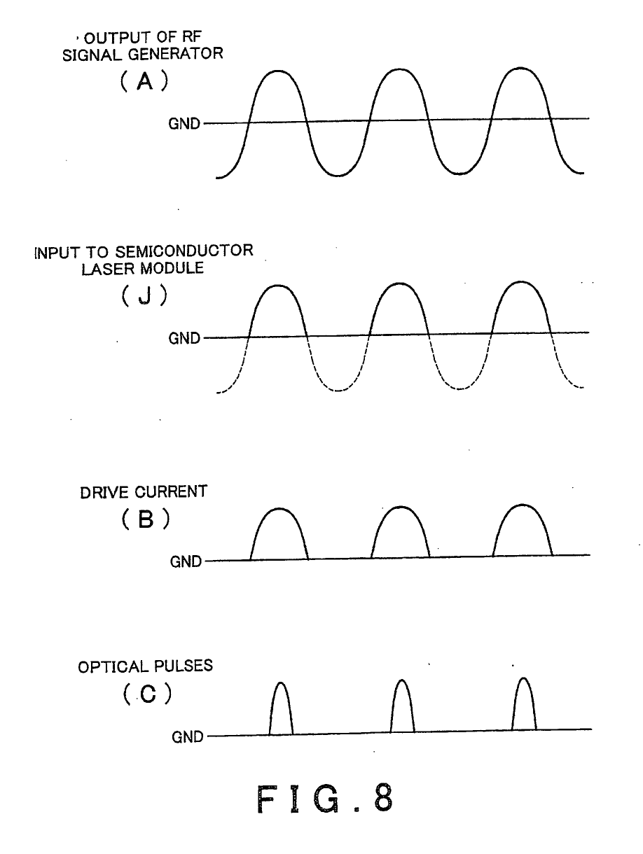

FIG. 8 shows the signal waveforms at given locations of the optical pulse generator 400 shown in FIG. 7. As shown in FIG. 8, in the optical pulse generator 400 too, the signal waveform (A) of an RF signal output from the RF signal generator 110 is a sinusoidal waveform having an amplitude symmetric with respect to the ground potential. Accordingly, the waveform (not shown) output from the RF amplifier 120 as obtained by amplifying the RF signal having the signal waveform (A) is also a signal waveform symmetric with respect to the ground potential.

However, the rectifier 150 is connected between the RF amplifier 120 and the semiconductor laser module 180. Accordingly, the signal waveform (J) of the signal input to the semiconductor laser module 180 does not include the amplitude of the period in which the signal is lower than the ground potential. Hence, the drive current that is to be injected into the semiconductor laser 140 of the semiconductor laser module 180 has the signal waveform (B) the same as that of the drive current for the optical pulse generator 100 shown in FIG. 1. Accordingly, the signal waveform (C) of the optical pulses to be emitted from the output port optical fiber 170 is the same as the pulses from the optical pulse generator 100.

Hence, there is provided a semiconductor laser drive apparatus 185 that includes: the RF signal generator 110 which generates and outputs an RF signal having a signal waveform in which the potential of the signal is alternately positive and negative with respect to the reference potential; and the rectifier 150 which receives at its one end a drive current which is based on the signal output from the RF signal generator 110, so that the semiconductor laser drive apparatus 185 drives the semiconductor laser 140 which receives the drive current at its one end having a polar directivity opposite to that of the one end of the rectifier 150 and has its other end connected to a potential common to the other end of the rectifier 150. Hence, the semiconductor laser module 180 is supplied with a drive current that includes neither direct current component that causes the semiconductor laser 140 to emit light constantly, nor oppositely-directed current that might destroy the semiconductor laser 140. Accordingly, any timing jitter due to the fluctuation of photon density is reduced. Further, by separately providing the semiconductor laser drive apparatus 185 which is enclosed by a broken line in FIG. 7, it is possible to generate optical pulses with less timing jitter, by using an existing semiconductor laser module 180.

Although some aspects of the present invention have been described by way of exemplary embodiments, the technical scope of the present invention is not limited to the scope of disclosure of the above-described embodiments. Various modifications or alterations can be made upon the above-described embodiments. It is obvious from the claims that any embodiment upon which such modifications or alterations are made is also included in the technical scope of the present invention.

What is claimed is:

1. An optical pulse generator, comprising:
an RF signal generator which generates and outputs an RF signal having a signal waveform in which potential of the signal changes to be positive and negative with respect to a reference potential;
a semiconductor laser which receives, at its one end, a drive current which is based on the signal output from the RF signal generator; and
a rectifying element which receives the drive current at its one end that has a polar directivity opposite to that of the one end of the semiconductor laser,
wherein the other end of the semiconductor laser and the other end of the rectifying element are connected to a common potential.

2. The optical pulse generator according to claim 1,
wherein the potential of the signal output from the RF signal generator changes symmetrically with respect to a ground potential.

3. The optical pulse generator according to claim 1,
wherein the signal output from the RF signal generator changes symmetrically with respect to a current value which is equal to or lower than a threshold current of the semiconductor laser.

4. The optical pulse generator according to claim 1,
wherein the rectifying element is a semiconductor laser.

5. The optical pulse generator according to claim 1,
wherein the one end of the semiconductor laser is connected to the RF signal generator via an impedance matching device.

6. The optical pulse generator according to claim 1,
wherein an output of the RF signal generator is connected, via an impedance matching device, to the one end of the semiconductor laser and to the one end of the rectifying element.

7. A semiconductor laser module that is supplied with a drive current from an RF signal generator which generates and outputs an RF signal having a signal waveform in which potential of the signal changes to be positive and negative with respect to a reference potential, the semiconductor laser module comprising:
a semiconductor laser which receives, at its one end, a drive current which is based on the RF signal; and
a rectifying element which receives the drive current at its one end which has a polar directivity opposite to that of the one end of the semiconductor laser,
wherein the other end of the semiconductor laser and the other end of the rectifying element are connected to a common potential.

8. A semiconductor laser drive apparatus, comprising:
an RF signal generator which generates and outputs an RF signal having a signal waveform in which potential of the signal changes to be positive and negative with respect to a reference potential; and
a rectifying element which receives, at its one end, a drive current which is based on the signal output from the RF signal generator,
wherein the semiconductor laser drive apparatus drives a semiconductor laser which receives the drive current at its one end having a polar directivity opposite to that of the one end of the rectifying element, and which has its other end connected to a potential common to the other end of the rectifying element.
